(19) United States
(12) Patent Application Publication
(10) Pub. No.: US 2025/0389131 A1
(43) Pub. Date: Dec. 25, 2025

(54) POOL CLEANER WITH SCOURING JETS

(71) Applicant: Pentair, Inc., Minneapolis, MN (US)

(72) Inventors: Montie Roland, Sanford, NC (US); Rob Keehner, Clayton, NC (US)

(21) Appl. No.: 19/246,441

(22) Filed: Jun. 23, 2025

Related U.S. Application Data
(60) Provisional application No. 63/662,750, filed on Jun. 21, 2024.

(51) Int. Cl. E04H 4/16; B08B 3/02

(52) U.S. Cl. CPC E04H 4/1654; B08B 3/024

(57) ABSTRACT

An inlet flow director for a pool cleaner is disclosed. The inlet flow director includes a collector having an intake portion. The inlet flow director also includes a scourer connected to the collector, the scourer having one or more side walls. The inlet flow director further includes one or more jets positioned in and extending through the one or more side walls. The one or more jets direct debris toward the intake portion.

### CROSS-REFERENCE TO RELATED APPLICATION

This application claims priority under 35 U.S.C. § 119 to U.S. Provisional Application No. 63/662,750, filed Jun. 21, 2024, the entirety of which is hereby incorporated by reference.

### TECHNOLOGY FIELD

This disclosure generally relates to pool cleaners. More specifically, the disclosure relates to an inlet flow director and a retractable skirt for a pool cleaner.

### BACKGROUND

Submersible pool cleaners are often used to maintain swimming pools. Such pool cleaners are often powered by pressurized water flow conveyed by a hose from a pump. To clean a pool, the pool cleaner moves along a surface of the pool, such as the bottom or floor of the pool, and removes debris via a venturi vacuum effect. Water and debris are conveyed out of the pool, the debris is filtered from the water, and the clean water is returned to the pool. In some instances, a pool cleaner may not be able to pull debris into the cleaner.

Pool cleaners may use a venturi effect vacuum to remove debris from a pool surface. However, in some instances, the venturi effect vacuum may be unable to remove debris that is adhered to the pool surface. Additionally, in some instances, debris may drift away from the pool cleaner and escape the venturi effect vacuum.

As such, there is a need for an improved pool cleaner that is designed to dislodge debris from the pool surface and direct the debris toward a debris collector and/or a venturi effect vacuum.

### SUMMARY

Aspects described herein are generally directed to a flow director for a pool cleaner.

In one aspect, an inlet flow director for a pool cleaner is provided. The inlet flow director includes a collector having an intake portion, a scourer connected to the collector, the scourer having one or more side walls, and one or more jets positioned in and extending through the one or more side walls. The one or more jets direct debris toward the intake portion.

In some instances, the scourer is coupled to the collector via a connector.

In some instances, the one or more jets are oriented to spray fluid streams to dislodge the debris from a pool surface to direct the debris toward the intake portion.

In some instances, the one or more jets are moveable relative to the one or more side walls.

In other instances, the inlet flow director further includes one or more mounting assemblies each of the one or more mounting assemblies having a receiver, a mounting opening, and a retaining collar. In some instances, the one or more mounting assemblies are positioned in the one or more side walls of the scourer. In some instances, a coupler of each jet is positioned about the one or more mounting assemblies and is retained by the retaining collar. In other instances, a sprayer of each jet is positioned about the one or more mounting assemblies and protrudes through the receiver.

In some instances, the scourer is imparted with a substantially trapezoidal shape.

In other instances, each of the one or more jets include a mounting ball, a coupler, and a sprayer extending from the mounting ball. In some instances, the mounting ball, the coupler, and the sprayer define a partially conical jet channel.

In other instances, the inlet flow director further includes a supply chamber. In some instances, the supply chamber provides pressurized water to the one or more jets.

In another aspect, an inlet flow director for a pool cleaner is disclosed. The inlet flow director includes a central section with an inlet passage positioned therein and one or more supply arms extending from the central section. The one or more supply arms are designed to provide a supply of pressurized water. The inlet flow director also includes one or more jet arms extending from the central section in a direction that is opposite the one or more supply arms. The one or more jet arms including one or more jets and the one or more jets are oriented to spray fluid streams to dislodge debris from a pool surface and direct the debris toward the inlet passage.

In some instances, each of the one or more jets includes an inlet and an outlet. In some instances, the one or more jet arms include one or more jet openings. The inlet of each of the one or more jets is connected to the one or more jet arms via the one or more jet openings.

In some instances, the one or more jets are movable relative to the one or more jet arms.

In some instances, the fluid streams of water produced by the one or more jets overlap to form a first virtual fence and a second virtual fence to direct the debris toward the inlet passage.

In other instances, the inlet flow director further includes a flow chamber. The one or more supply arms provide pressurized water to the one or more jets via the flow chamber.

In a further aspect, a pool cleaner is provided. The pool cleaner includes a body having a suction passage and a retractable skirt coupled to the body of the pool cleaner. The retractable skirt has a scoop plate with a front surface extending between a first end plate and a second end plate and one or more ribs positioned between the first end plate and the second end plate. The one or more ribs extending outwardly from the front surface of the scoop plate and positioned parallel to the first end plate and the second end plate. The retractable skirt dislodges debris from a pool surface and directs the debris toward the suction passage.

In some instances, the retractable skirt includes a pivot opening on the scoop plate designed to pivot about a pivot axis to slide over one or more fixed obstacles on the pool surface.

### BRIEF DESCRIPTION OF THE DRAWINGS

FIG. 1 is a front isometric view of an example pool cleaner in accordance with the teachings of this disclosure;

FIG. 2 is a rear isometric view of the pool cleaner of FIG. 1;

FIG. 3 is a bottom view of a first example inlet flow director of the pool cleaner of FIG. 1 in accordance with the teachings of this disclosure;

FIG. 4 is a partial front isometric view of the first example inlet flow director of FIG. 3;

FIG. 5 is a cross-sectional view of the first example inlet flow director of FIG. 3 taken along line A-A of FIG. 3;

FIG. 6 is a bottom isometric view of a second example inlet flow director for use with the pool cleaner of FIG. 1 in accordance with the teachings of this disclosure;

FIG. 7 is an enlarged partial bottom view of the second example inlet flow director of FIG. 6;

FIG. 8 is an enlarged partial top isometric view of the second example inlet flow director of FIG. 6;

FIG. 9 is an enlarged partial view of the second example inlet flow director of FIG. 6;

FIG. 10 is a bottom isometric view of a third example inlet flow director for use with the pool cleaner of FIG. 1 in accordance with the teachings of this disclosure;

FIG. 11 is a top isometric view of a fourth example inlet flow director for use with the pool cleaner of FIG. 1 in accordance with the teachings of this disclosure;

FIG. 12 is a partial bottom cross-sectional view of the fourth example inlet flow director of FIG. 11 taken along the line B-B of FIG. 11;

FIG. 13 is a partial elevational cross-sectional view of the fourth example inlet flow director of FIG. 11 taken along the line C-C of FIG. 11;

FIG. 14 is an exploded partial bottom isometric view of a fifth example inlet flow director for use with the pool cleaner of FIG. 1 in accordance with the teachings of this disclosure;

FIG. 15 is a schematic view of the fifth example inlet flow director of FIG. 14;

FIG. 16 is a schematic view of a sixth example inlet flow director for use with the pool cleaner of FIG. 1 in accordance with the teachings of this disclosure;

FIG. 17 is an isometric view of a retractable skirt for use with the pool cleaner of FIG. 1 in accordance with the teachings of this disclosure;

FIG. 18 is a side elevational view of the retractable skirt of FIG. 17 with hidden features of the retractable skirt shown in dashed lines; and

FIG. 19 is a partial side elevational view of the retractable skirt of FIG. 17 in operation.

### DETAILED DESCRIPTION

The following discussion is presented to enable a person skilled in the art to make and use aspects of the disclosure. Various modifications to the illustrated aspects will be readily apparent to those skilled in the art, and the generic principles herein can be applied to other aspects and applications without departing from aspects of the disclosure. Thus, aspects of the disclosure are not intended to be limited to aspects shown but are to be accorded the widest scope consistent with the principles and features disclosed herein.

The following detailed description is to be read with reference to the figures, in which like elements in different figures have like reference numerals. The figures, which are not necessarily to scale, depict selected aspects and are not intended to limit the scope of aspects of the disclosure. Skilled artisans will recognize the examples provided herein have many useful alternatives and fall within the scope of aspects of the disclosure. The disclosure is capable of other aspects and of being practiced or of being carried out in various ways. Also, it is to be understood that the phraseology and terminology used herein are for the purpose of description and should not be regarded as limiting. For example, the use of “including,” “comprising,” or “having” and variations thereof herein is meant to encompass the items listed thereafter and equivalents thereof as well as additional items.

As used herein, unless otherwise specified or limited, the terms “mounted,” “connected,” “supported,” and “coupled” and variations thereof are used broadly and encompass both direct and indirect mountings, connections, supports, and couplings. Further, unless otherwise specified or limited, “connected” and “coupled” are not restricted to physical or mechanical connections or couplings, but can also refer to communicative, electrical, or fluidic couplings.

As used herein, unless otherwise specified or limited, “at least one of A, B, and C,” and similar other phrases, are meant to indicate A, or B, or C, or any combination of A, B, and/or C. As such, this phrase, and similar other phrases can include single or multiple instances of A, B, and/or C, and, in the case that any of A, B, and/or C indicates a category of elements, single or multiple instances of any of the elements of the categories A, B, and/or C.

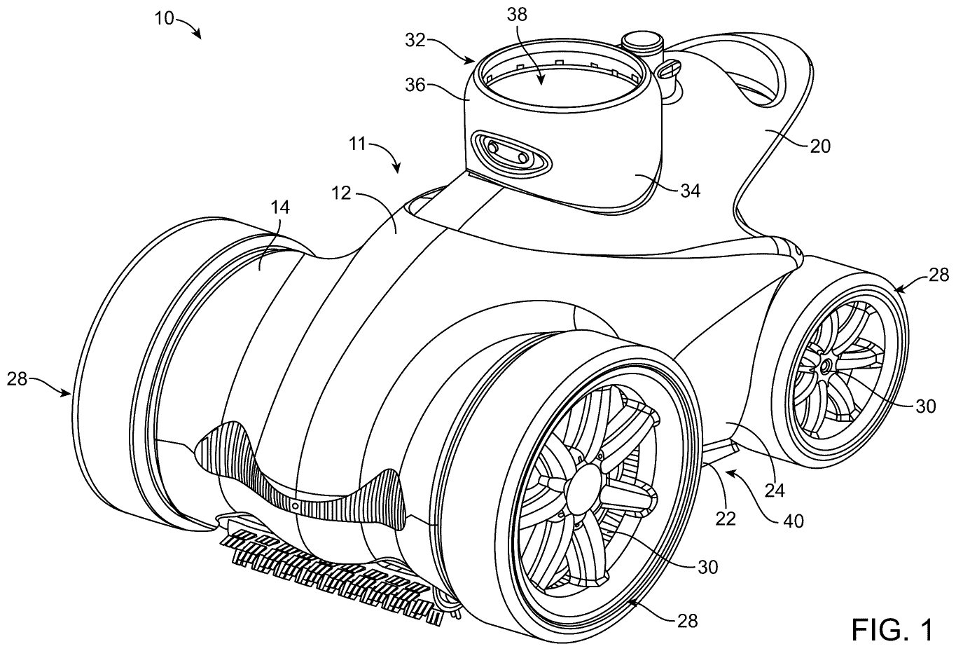

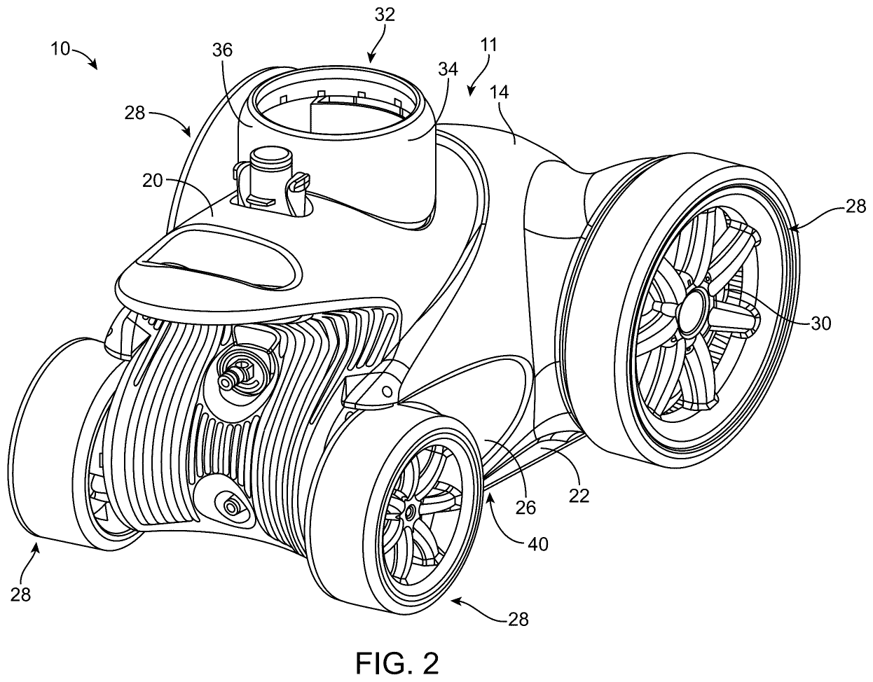

FIGS. 1 and 2 illustrate an example pool cleaner 10 in accordance with the teachings of this disclosure. In some instances, the pool cleaner 10 may be a pressure-side pool cleaner powered by a pump of an aquatic swimming pool system or a booster pump and may be designed to automatically remove debris from a floor and/or sides of a swimming pool or spa. The pool cleaner 10 may include precise directional control, enhanced suction, and additional scrubbing capabilities. In some aspects, the pool cleaner 10 may be provided in the form of a robotic pool cleaner, a motor driven cleaner, or other swimming pool cleaners known in the art.

As shown in FIGS. 1 and 2, the pool cleaner 10 may include a body 11. The body 11 may include a cover assembly 12 having a front cover 14, a rear cover 16, a front grill 18, a top cover 20, a bottom cover 22, and two side covers 24, 26. The pool cleaner 10 can also include a plurality of wheels 28. In some aspects, one or more of the plurality of wheels 28 may be movably coupled to the body 11 and may be drivably rotated via inner teeth 30. In other aspects, the one or more of the plurality of wheels 28 may be freely rotatable. In some instances, the outer portion of each wheel 28 may be substantially smooth. In other instances, the outer portion of each wheel 28 may include treads for better traction across a pool floor or surface. In some aspects, the wheels 28 may differ in size from front to rear of the pool cleaner 10. In some aspects, the cover assembly 12 and the wheels 28 can be constructed of plastic or similar materials. An exemplary pool cleaner is described in U.S. Pat. Nos. 8,990,990, 10,125,509, and 11,118,369, incorporated herein by reference.

In operation, the pool cleaner 10 may traverse the pool and vacuum, or pick up, debris from the pool surface and deposit the debris in a debris collection system (not shown) via a venturi vacuum assembly 32. The venturi vacuum assembly 32 may be formed integrally with or coupled to the body 11 and may include a suction mast 34, one or more venturi nozzle assemblies (not shown), and an attachment collar 36. In some instances, the suction mast 34 may define an intake or suction passage 38 through which water and debris pass from an underside 40 of the pool cleaner 10. The attachment collar 36 may be removably coupled to the suction mast 34 and, in some instances, may be used to secure the debris collection system, such as a debris bag or a debris canister, to the suction mast 34 for collecting the retrieved debris. In other instances, suction mast 34 and/or the debris collection system may be positioned within the cover assembly 12. The venturi nozzle assemblies may be coupled to or integral with one or more parts of the pool cleaner 10 such as the side covers 24, 26, the suction mast 34, and/or the attachment collar 36. The venturi nozzle assemblies may provide a flow of pressurized water up through the suction mast 34 to create a pressure difference, or venturi effect, within the suction mast 34. The pressure difference can cause a suctioning effect to vacuum up debris directly under and surrounding the underside 40 of the pool cleaner 10. Within some examples, the venturi effect produces water flow through a constricted section of pipe or other conduit which increases velocity while decreasing in pressure. The drop in pressure creates suction allowing the pool cleaner 10 to draw debris and dirt from the pool surface into the pool cleaner 10. Within some examples described herein and with respect to other pool cleaners known in the art, the pool cleaner 10 may operate without the use of electricity to produce the venturi effect, thus relying solely on water flow to generate suction.

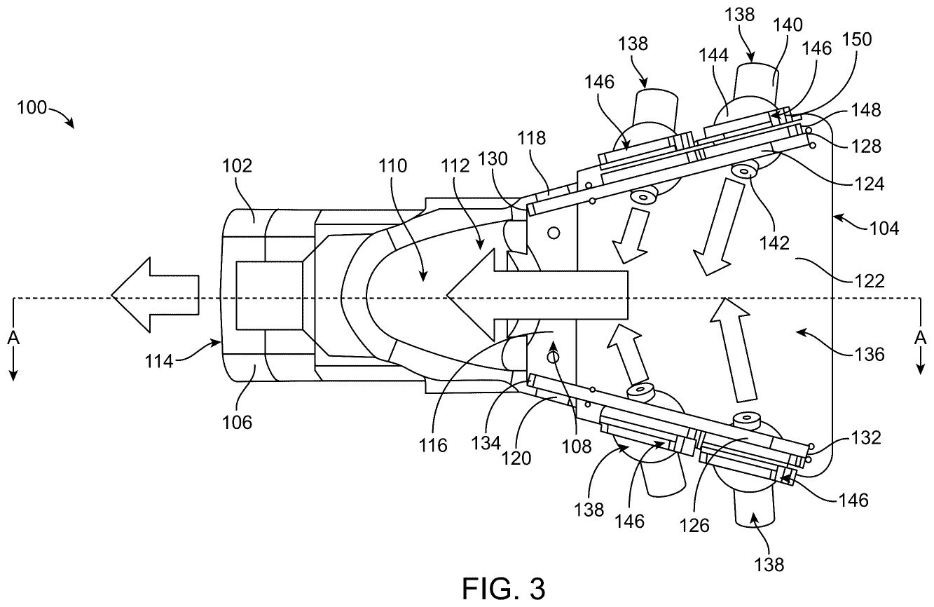

FIG. 3 illustrates a first example inlet flow director 100 in accordance with the teachings of this disclosure. In some instances, the inlet flow director 100 may be included in the pool cleaner 10 of FIGS. 1 and 2. In other instances, the inlet flow director 100 may be added onto or used in conjunction with the pool cleaner 10. For example, in some instances the inlet flow director 300 may be coupled to the body 11 of pool cleaner 10. The inlet flow director 100 may be designed to direct debris toward an intake or suction passage, such as suction passage 38 of pool cleaner 10 (shown in FIG. 1), through which the debris is carried via venturi effect suction toward the debris collection system (not shown). In other examples, the inlet flow director 100 may be adapted for compatibility with a range of pool cleaning devices to accommodate various pool surfaces and user preferences. The design of the inlet flow director 100 may incorporate modular features to facilitate retrofitting onto existing pool cleaner models, enhancing versatility and ease of installation.

Still referring to FIG. 3, the inlet flow director 100 may include a collector 102 and a scourer 104. The collector 102 may be provided in the form of a tube body 106 having a connector 108. The connector 108 may be any variety of shapes and sizes for coupling to various elements of the inlet flow director 100. The tube body 106 may define an intake passage 110, an upstream opening 112, and a downstream opening 114, whereby the upstream opening 112 is in fluid communication with the downstream opening 114 via the intake passage 110. The downstream opening 114 may be provided between the connector 108 and the upstream opening 112. The connector 108 may include a top lobe 116 connected to a first side lobe 118 and to a second side lobe 120. The connector 108 may engage and thus connect or link the scourer 104 to the tube body 106 of the collector 102. Within some examples, the collector 102 may also include a debris basket or similar device for collecting debris flowing through the inlet flow director 100. In some instances, the debris basket may be positioned on the end of the downstream opening 114.

Still referring to FIG. 3, the scourer 104 may include a top wall 122 connected to a first side wall 124 and a second side wall 126. The first side wall 124 may be defined by a first upstream edge 128 and a first downstream edge 130, and the second side wall 126 may be defined by a second upstream edge 132 and a second downstream edge 134. The first downstream edge 130 and the second downstream edge 134 may be closer to one another than the first upstream edge 128 and the second upstream edge 132. Thus, the top wall 122, the first side wall 124, and the second side wall 126 may form a flow channel 136 that is substantially trapezoidal or trapezoidal. Additionally, in some instances, the top wall 122 may overhang the first upstream edge 128 and the second upstream edge 132. It should be known that the first side wall 124 and the second side wall 126 may be substantially positioned or angled in other directions allowing appropriate fluid flow to the upstream opening 112 of the intake passage 110 based on the pool cleaner 10 architecture.

The scourer 104 may also include one or more jets 138. The one or more jets 138 may be mounted to the first side wall 124 and/or the second side wall 126 via one or more mounting assemblies 146 positioned therein. In some instances, the one or more jets 138 may extend through the first side wall 124 and/or the second side wall 126. In some examples, the one of more jets 138 may be mounted to the first side wall 124 and/or the second side wall 126 via the one or more mounting assemblies 146 such that the one or more jets 138 are movable or swivelably movable relative the first side wall 124 and/or the second side wall 126. Each of the one or more jets 138 may include a coupler 140 and a sprayer 142 extending from a mounting ball 144.

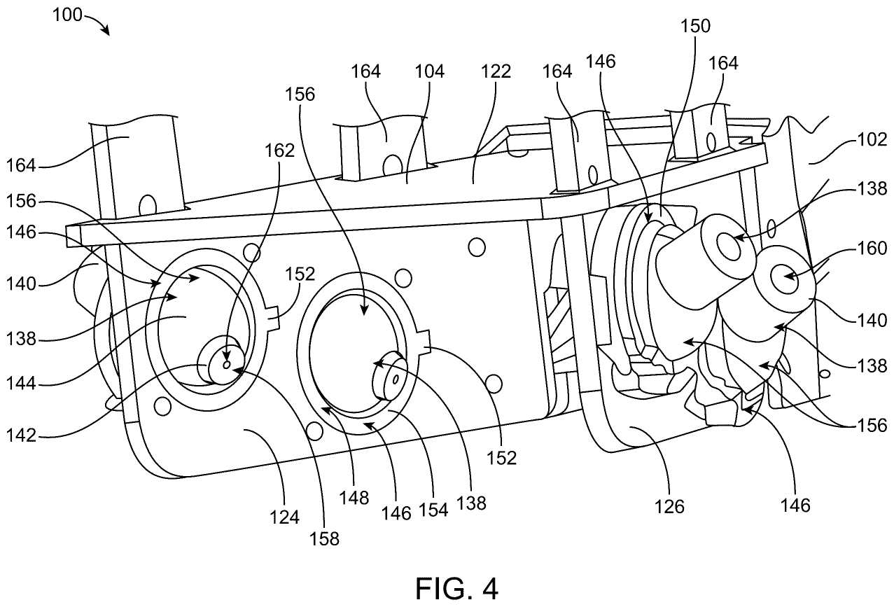

As best shown in FIG. 4, in some instances, each of the one or more mounting assemblies 146 may include a receiver 148 and a retaining collar 150. In some instances, the receiver 148 may be positioned on an interior of the first side wall 124 and/or the second side wall 126, and the retaining collar 150 may be positioned on an exterior of the first side wall 124 and/or the second side wall 126. As shown in FIG. 4, the retaining collar 150 may surround each of the one or more jets 138. For example, the coupler 140 of each jet 138 may be positioned about one of the one or more mounting assemblies 146 and retained by the retaining collar 150, and the sprayer 142 of each jet 138 may be positioned about one of the one or more mounting assemblies 146 and may protrudes through the receiver 148.

Each receiver 148 may include a key 152 extending radially from a seat ring 154. Further, each receiver 148 may fit into mount openings 156 that extend through the first side wall 124 and the second side wall 126. The mount openings, in some examples, may be circular or ovular in shape; in other examples, the mount openings may be any suitable shape. Each receiver 148 may be non-rotatable relative to the first side wall 124 and the second side wall 126 of the scourer 104 because of the key 152. In some instances, the key 152 may be shaped to align with a notch (not shown) of the first side wall 124 and/or the second side wall 126 for mounting each of the receivers 148 into the first side wall 124 and/or the second side wall 126.

Still referring to FIG. 4, the coupler 140, the sprayer 142, and the mounting ball 144 of the one or more jets 138 may define a jet channel 158 having an inlet opening 160 and an outlet opening 162. In some instances, each coupler 140 may define the inlet opening 160. The inlet opening 160 may be configured to fluidly communicate with a fluid supply (not shown). Each sprayer 142 may define the outlet opening 162. The outlet opening 162 may be configured to emit a fluid into the flow channel 136. In some aspects, the jet channel 158 may be at least partially conical in shape, with the outlet opening 162 having a diameter that is narrower or smaller than the diameter of the inlet opening 160, thereby forming a converging nozzle geometry. The conical shape may be characterized by a taper angle, which can be selected based on desired fluid velocity and spray pattern characteristics or application requirements. Within some examples, the jet channel 158 may run along the entirety of the jet 138, extending from the inlet opening 160, through the mounting ball 144, and to the outlet opening 162.

Although not shown within FIG. 4, the internal surface of the jet channel 158 may be smooth or may include surface texturing or flow-directing features (e.g., helical grooves or vanes) to influence the fluid dynamics, reduce turbulence, or promote a specific spray pattern. The cross-sectional profile of the jet channel 158 may be circular, elliptical, or otherwise shaped to optimize fluid flow characteristics.

The scourer 104 may also include one or more mounting protrusions 164. In some aspects, the mounting protrusions 164 may extend from the first side wall 124 and/or the second side wall 126. In some instances, the one or more mounting protrusions 164 may be integrally formed with the top wall 122. In other instances, the one or more mounting protrusions 164 may be attached to or extend through the top wall 122. The mounting protrusions 164 may be used to attach the inlet director 100 to the pool cleaner 10 (for example, via the body 11) or another debris collecting device.

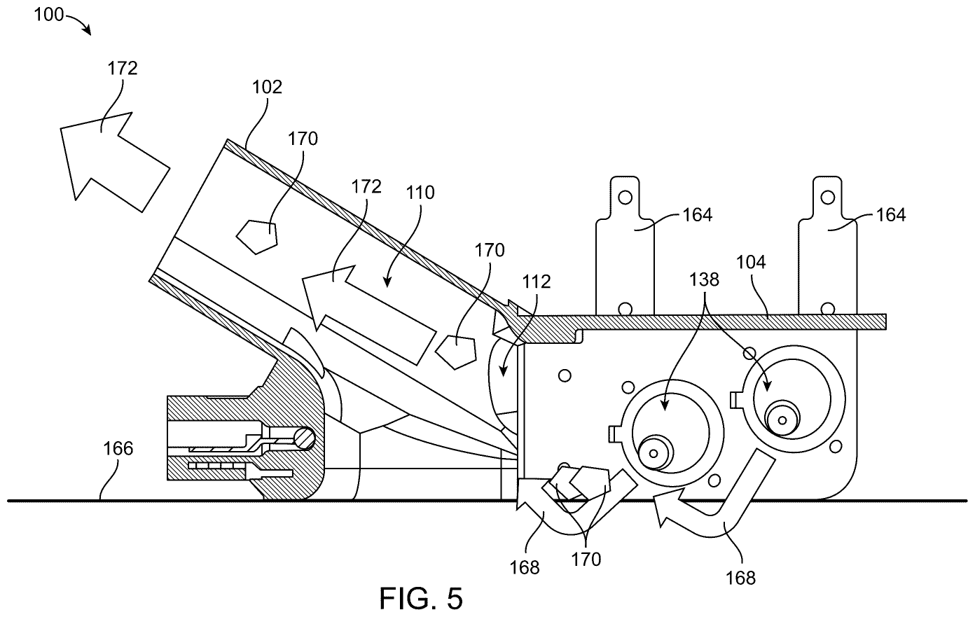

Referring to FIG. 5, in operation, the jets 138 may be oriented downwardly in the scourer 104 to spray a pool surface 166 obliquely, as indicated by a first fluid flow path represented by jet arrows 168. Thus, as the pool cleaner 10 with the inlet flow director 100 moves along the pool surface 166 (e.g., a pool floor), the jets 138 work to spray, stir up, dislodge, and/or direct debris 170 from the pool surface 166 toward the upstream opening 112 and into the intake passage 110. In some embodiments, the angle of the jets 138 relative to the pool surface 166 may be selected to optimize debris agitation and movement. The jets 138 may be configured to deliver fluid at a pressure and flow rate suitable for effective debris mobilization, which may be determined based on the characteristics of the pool environment and the debris to be removed. The spray pattern produced by each jet 138 may be adjusted by selecting appropriate geometries for a particular application. Further in operation, once the debris 170 enters the intake passage 110, the debris 170 may be moved via a venturi effect through the intake passage 110 toward a debris collection system (not shown), as indicated by a second fluid flow path represented by flow arrows 172. The venturi effect may be achieved by a constriction within the intake passage 110 capable of moving the fluid velocity creating a localized low-pressure region, thereby enhancing suction and debris transport efficiency. In some configurations, sensors or flow meters may be integrated within the intake passage 110 to monitor fluid velocity and detect blockages, providing feedback to the control system for maintenance or operational adjustment.

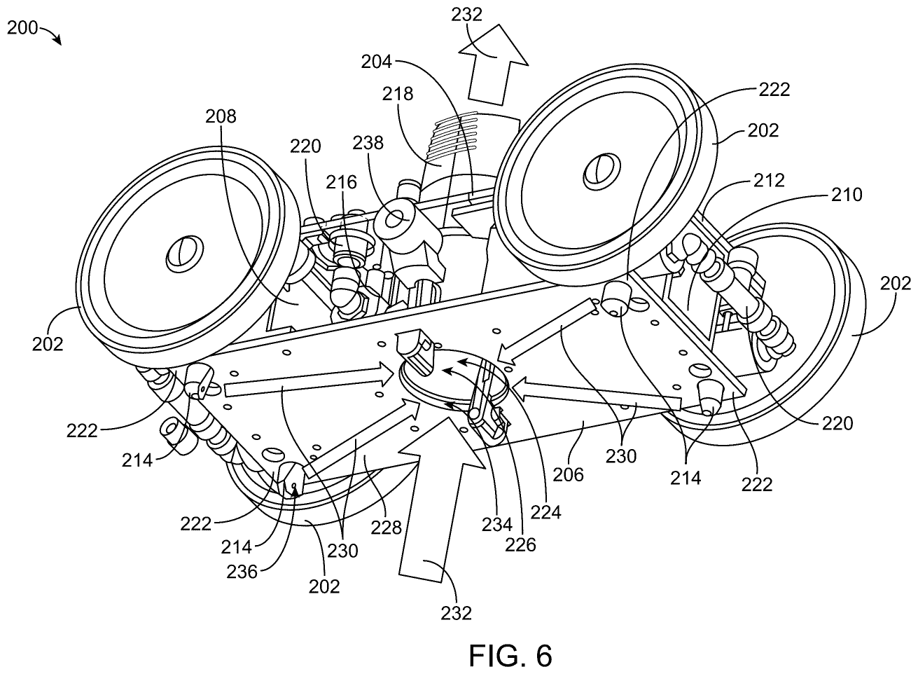

FIG. 6 illustrates a second example inlet flow director 200 in accordance with the teachings of this disclosure. In some examples, the inlet flow director 200 may be included in the pool cleaner 10 of FIGS. 1 and 2 and/or may be added onto and thus used in conjunction with the pool cleaner 10. In some aspects, the inlet flow director 200 may be included in a robotic pool cleaner (not shown) and/or may be added onto and thus used in conjunction with the robotic pool cleaner. The inlet flow director 200 may be designed to direct debris toward the suction mast 34 (shown in FIG. 1), by which the debris is carried via suction toward the debris collection system (not shown). A pool cleaner having the inlet flow director 200 may include a plurality of wheels 202 rotatably mounted to a chassis 204. It should be understood that the plurality of wheels 202 are shown as examples. In some aspects, the plurality of wheels 28 of FIGS. 1 and 2 may be rotatably mounted to the chassis 204 in place of the wheels 202. In other examples, the inlet flow director 200 may be adapted for compatibility with a range of pool cleaning devices having a variety of drive mechanisms, such as tracks or rollers, to accommodate various pool surfaces and user preferences. The design of the inlet flow director 200 may incorporate modular features to facilitate retrofitting onto existing pool cleaner models, enhancing versatility and ease of installation.

The chassis 204 may include a lower plate 206 mounted to a first support 208 and a second support 210. The chassis 204 may further include an upper plate 212 mounted to the first support 208 and the second support 210. The first support 208 and the second support 210 may be axially aligned with one another along the lower plate 206 and the upper plate 212. Additionally, the first support 208 and the second support 210 may be spaced apart from one another along the lower plate 206 and the upper plate 212. Further, the first support 208 and the second support 210 may be medially located transversely across the lower plate 206 and the upper plate 212. In some aspects, the first support 208 and the second support 210 may be at least partially formed of rectangular box tube. Further, the plurality of wheels 202 may be rotatably mounted to the first support 208 and the second support 210. The supports 208 and 210 may be reinforced or provided with additional structural features to enhance rigidity and durability during operation. The mounting arrangement for the wheels 202 may also include bearings or bushings to reduce friction and ensure smooth rotation during movement.

Still referring to FIG. 6, the chassis 204 may include one or more jets 214, a manifold 216, a suction mast 218, and supply lines 220. The one or more jets 214 may be supported by and extend through the lower plate 206. As shown, each of the one or more jets 214 may be located at a corner 222 of the lower plate 206. Although the chassis 204 is depicted as rectangular, the chassis 204 may be any suitable shape (e.g., triangular, polygonal, ellipsoid, ovate, circular, etc.). Thus, the one or more jets 214 may be axially and transversely spaced apart from one another along and across the lower plate 206. Additionally, in some instances, the one or more jets 214 may be individually removable. For example, any of the one or more jets 214 may be swapped with a different jet or removed to produce differing, customizable spray patterns along the lower plate 206. The one or more jets 214 may also be individually swapped or removed to facilitate maintenance of the inlet flow director 200. The manifold 216 may be mounted to the lower plate 206 and designed to supply water to the one or more jets 214 via the supply lines 220. The suction mast 218 may be mounted to the lower plate 206 and may define a suction passage 224. The lower plate 206 may define a suction opening 226 that is in fluid communication with the suction passage 224. Thus, the suction passage 224 may be in fluid communication with an underside 228 of the lower plate 206.

Further, the configuration of the one or more jets 214 may be optimized to generate targeted fluid streams that enhance debris mobilization from various regions beneath the chassis 204. The manifold 216 and supply lines 220 may be constructed with flexible or rigid tubing and may include quick-connect fittings for ease of assembly and disassembly. In some examples, the suction mast 218 may be shaped to minimize flow resistance and maximize the efficiency of debris transfer into the debris collection system. The suction opening 226 may be provided with a debris guard or screen to prevent large objects from entering and disrupting flow through the suction passage 224.

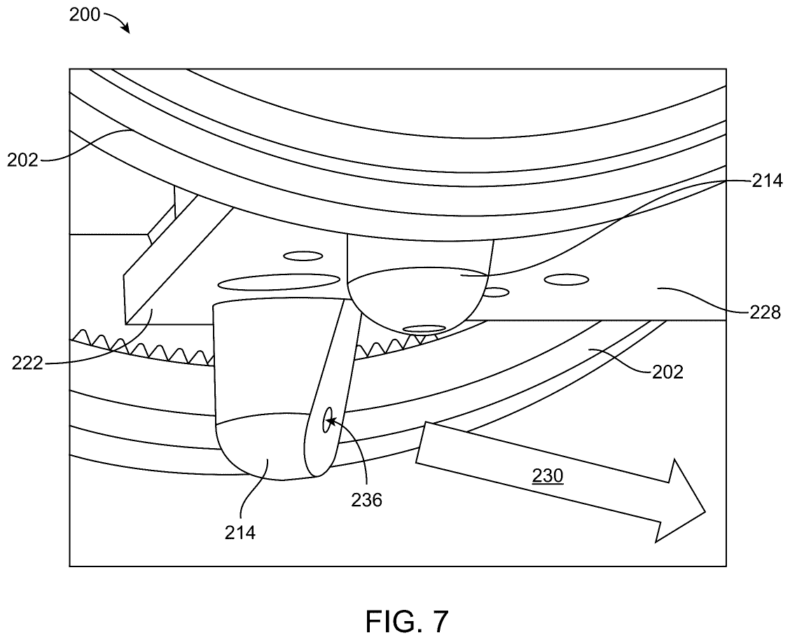

Shown in greater detail with respect to FIG. 7, of the one or more jets 214 may be oriented inwardly toward the suction mast 218 and obliquely downwardly to spray a pool surface (not shown), as indicated by jet arrows 230. Thus, as the inlet flow director 200 moves along the pool surface, the one or more jets 214 may work to spray, stir up, dislodge, and/or direct debris from the pool surface toward the suction opening 226 and into the suction passage 224. In some aspects, the one or more jets 214 may direct streams of fluid to strike the pool surface at an angle of 15 degrees or about 15 degrees. The angle of the one or more jets 214 may be selected based on the type of debris and the desired cleaning pattern, allowing for adaptable cleaning performance across different pool environments. The fluid streams generated by the one or more jets 214 may be controlled in terms of pressure and flow rate to suit the operational requirements of the pool cleaner 10.

Further in operation, in some instances, once the debris enters the suction passage 224, the debris may be moved via venturi effect through the suction passage 224 toward the debris collection system (not shown), as indicated by flow arrows 232. In some instances, once the debris enters the suction passage 224, the debris may be moved via suction induced by a pump (not shown) through the suction passage 224 toward the debris collection system, as indicated by flow arrows 232. The use of the venturi effect or pump-induced suction as described with respect to other elements described herein, may be selected or combined depending on the available water pressure, pool cleaner configuration, or user preference.

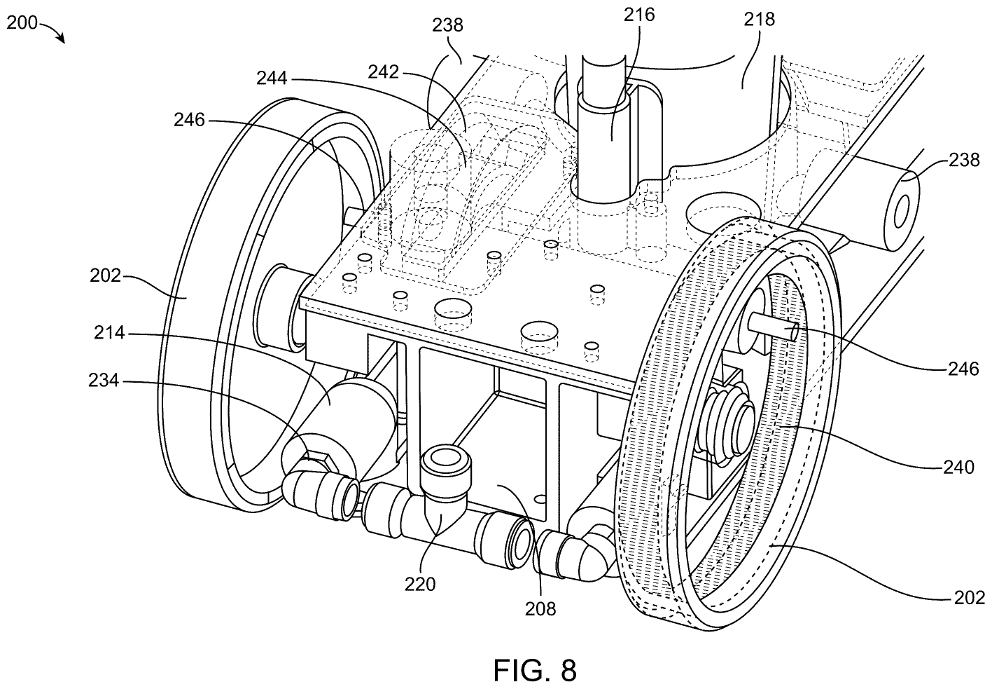

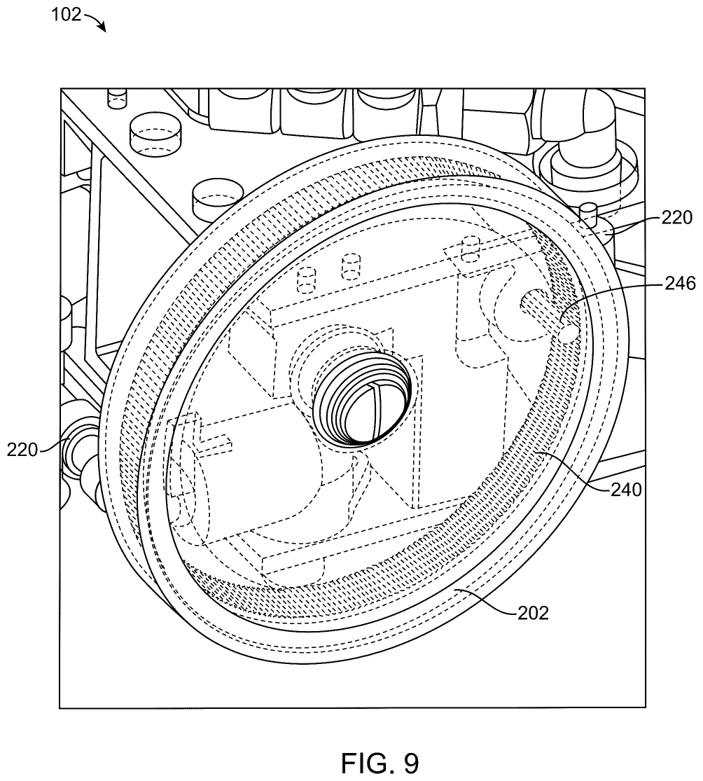

Turning to FIGS. 8 and 9, the inlet flow director 200 is shown in partial, enlarged views. Each of the one or more jets 214 may have an inlet opening 234 and an outlet opening 236, whereby the inlet openings 234 are connected to the supply lines 220. It should be understood that certain portions of the supply lines 220 are illustrated as separated and/or partially exploded for clarity. Although not shown, the connection between the one or more jets 214 and the supply lines 220 may utilize seals or gaskets to prevent leaks and maintain consistent fluid delivery. The one or more jets 214 may be designed for tool-less removal to facilitate cleaning or replacement during routine maintenance.

As best shown in FIG. 8, the chassis 204 may include venturi nozzles 238 mounted to and extending through the suction mast 218. The manifold 216 may supply water to the venturi nozzles 238 via the supply lines 220. In operation, the venturi nozzles 238 may spray pressurized water up through the suction mast 218 to create a pressure difference, or venturi effect, within the suction mast 218. The pressure difference can cause a suctioning effect to vacuum up debris directly under and surrounding the lower plate 206. Within some examples, the venturi nozzles 238 may be selectively activated or deactivated to adjust suction force as needed during operation. The venturi nozzles 238 may be tailored to optimize the balance between water usage and suction efficiency for various cleaning scenarios. In some configurations, the venturi nozzles 238 may be accessible for inspection and cleaning to prevent blockages and maintain system performance.

One or more of the plurality of wheels 202 of the pool cleaner may include inner teeth 240. The chassis 204 may include a flow drive 242 mounted to the second support 210. The flow drive 242 may be provided in the form of a water wheel 244 and pinions 246. The manifold 216 may supply water to the flow drive 242 via the supply lines 220. In operation, water flowing through the flow drive 242 drives the wheels 202 via the pinions 246 and the inner teeth 240. Within some examples, the flow drive 242 may convert water flow into rotational energy with high efficiency, enabling smooth and reliable propulsion of the pool cleaner. The water wheel 244 may be sized and shaped to accommodate varying water flow rates and pressures, providing adaptability for different pool systems.

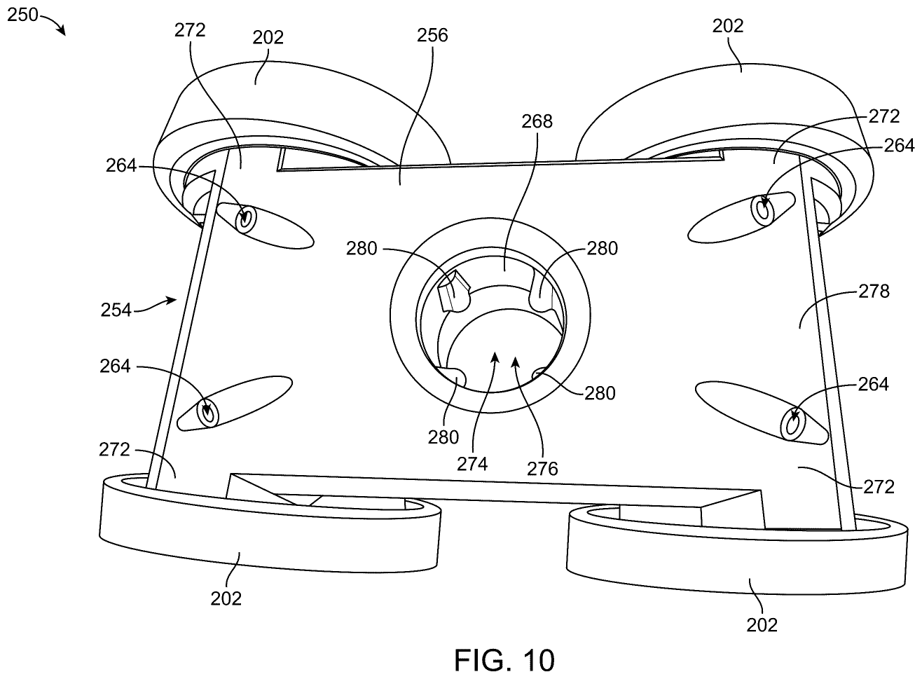

FIG. 10 illustrates a third example inlet flow director 250 in accordance with the teachings of this disclosure. In some aspects, the inlet flow director 250 may be included in the pool cleaner 10 of FIGS. 1 and 2 and/or may be added onto and thus used in conjunction with the pool cleaner 10. The inlet flow director 250 may be designed to direct debris toward the suction mast 34 (shown in FIG. 1), by which the debris is carried via suction toward the debris collection system (not shown). A pool cleaner (e.g., pool cleaner 10) having the inlet flow director 250 may include the plurality of wheels 202 rotatably mounted to a chassis 254. It should be understood that the plurality of wheels 202 are shown as examples. In some aspects, the plurality of wheels 28 of FIGS. 1 and 2 may be rotatably mounted to the chassis 254 in place of the wheels 202. Within some examples, the attachment mechanism for the inlet flow director 250 may include snap-fit connectors, threaded fasteners, or adhesive bonding, allowing for both permanent and removable installation based on various applications. Additionally, the inlet flow director 250 may incorporate flow guide vanes or baffles to further channel water and debris toward the suction mast 34, enhancing the overall cleaning efficiency. Sensors or passive flow indicators may be integrated into the inlet flow director 250 to monitor flow rates and detect blockages, thereby enabling adaptive control or maintenance alerts.

Still referring to FIG. 10, the chassis 254 may include a lower plate 256 having one or more jets 264 associated with opposing corners thereof. In some instances, the one or more jets 264 may be molded into and/or formed in the lower plate 256. In other instances, the one or more jets 264 may be coupled to the lower plate 256 by an adhesive, fastener, or other known methods in the art. In some instances, each of the one or more jets 264 may be located at a corner 272 of the lower plate 256, as shown. Although the chassis 254 is depicted as rectangular, the chassis 254 may be any suitable shape (e.g., triangular, polygonal, ellipsoid, ovate, circular, etc.). Thus, each of the one or more jets 264 may be axially and transversely spaced apart from one another along and across the chassis 254.

Further, the one or more jets 264 may be configured to generate high-velocity fluid streams by constricting the flow through a reduced diameter orifice, which may achieve a desired spray pattern and pressure. Each of the one or more jets 264 may include replaceable or adjustable nozzles to allow for maintenance or to tailor the spray characteristics for different pool surface types or debris loads. Additionally, the arrangement of the one or more jets 264 at the corners or other distributed locations on the lower plate 256 ensures coverage of the pool surface, reducing the likelihood of debris accumulation in regions not directly beneath the suction mast. Within other examples the lower plate 256 may be provided with reinforcement ribs or a honeycomb structure to maintain rigidity and prevent deformation under operational stresses, especially when larger jets or higher pressures are employed. Fluid flow to the one or more jets 264 may be modulated via electronically actuated valves or flow restrictors, which may be controlled manually or automatically based on detected debris levels or cleaning cycle parameters.

The chassis 254 may further include the manifold 216, the suction mast 218, and the supply lines 220 shown in FIG. 6, and a suction ring 268. The manifold 216 may be designed to supply water to the one or more jets 264 via the supply lines 220. The suction ring 268 may be mounted to the lower plate 256 and connected to the suction mast 218 and the suction ring 268 and the suction mast 218 may define a suction passage 274. The lower plate 256 may define a suction opening 276 that is in fluid communication with the suction passage 274. Thus, the suction passage 224 may be in fluid communication with an underside 278 of the lower plate 256. Further, the suction ring 268 may define a plurality of venturi nozzles 280. The plurality of venturi nozzles 280 may be molded into and/or formed in the suction ring 268.

Within some examples, the venturi nozzles 280 may be designed based on the Bernoulli principle, with a converging-diverging profile that accelerates fluid flow and generates a localized region of low pressure to enhance suction efficiency. The venturi nozzles 280 may be equipped with anti-clogging features such as integrated mesh screens or self-cleaning mechanisms that periodically reverse flow to dislodge trapped debris. The suction passage 274, being in fluid communication with the underside 278 of the lower plate 256, ensures that debris mobilized by the jets 264 is efficiently transported into the debris collection system with minimal loss due to recirculation or backflow.

In operation, the one or more jets 264 may be oriented inwardly toward the suction ring 268 and obliquely downwardly to spray a pool surface (not shown). Thus, as the inlet flow director 250 moves along the pool surface, the one or more jets 264 are designed to spray, stir up, dislodge, and/or direct debris from the pool surface toward the suction opening 276 and into the suction passage 274. In some aspects, the one or more jets 264 may direct streams of fluid to strike the pool surface at an angle of 15 degrees or about 15 degrees. Further in operation, once the debris enters the suction passage 274, the debris may be moved via venturi effect induced via the venturi nozzles 280 through the suction passage 274 toward the debris collection system (not shown).

In other aspects, the venturi effect generated by the nozzles 280 may increase the velocity of fluid and debris entering the suction passage 274 and may also help prevent clogging by continuously flushing the passage with accelerated water flow. The system may be further enhanced by integrating a feedback loop wherein sensors detect debris load and dynamically adjust jet pressure or suction power to optimize cleaning performance and energy efficiency. In some implementations, the control system may log operational parameters and cleaning coverage data for subsequent analysis and refinement of cleaning algorithms.

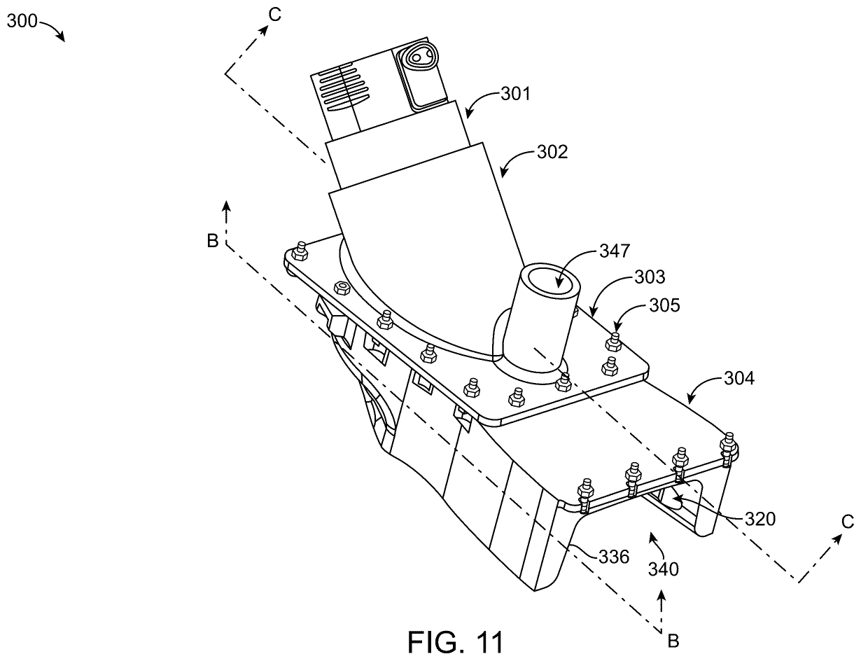

FIGS. 11-13 illustrates a fourth example inlet flow director 300 in accordance with the teachings of this disclosure. In some instances, the inlet flow director 300 may be included in the pool cleaner 10 of FIGS. 1 and 2. In other instances, the inlet flow director 300 may be added onto and thus used in conjunction with the pool cleaner 10. For example, in some instances the inlet flow director 300 may be coupled to the body 11 of the pool cleaner 10. The inlet flow director 300 may be designed to direct debris toward an intake or suction passage 301 (and/or the suction passage 38 of the pool cleaner shown in FIG. 1), through which the debris is carried via venturi effect suction toward the debris collection system (not shown). In other examples, the inlet flow director 300 may be adapted for compatibility with a range of pool cleaning devices to accommodate various pool surfaces and user preferences. The design of the inlet flow director 300 may incorporate modular features to facilitate retrofitting onto existing pool cleaner models, enhancing versatility and ease of installation.

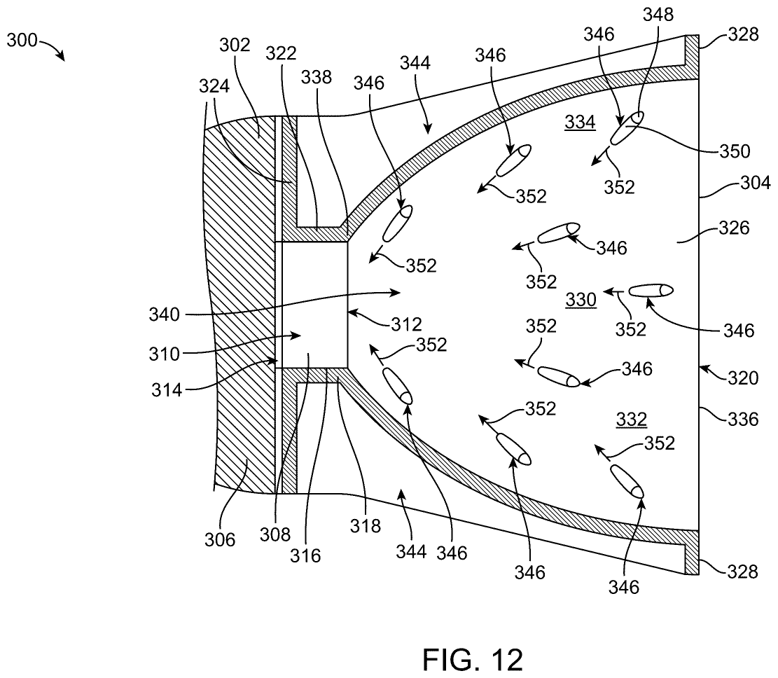

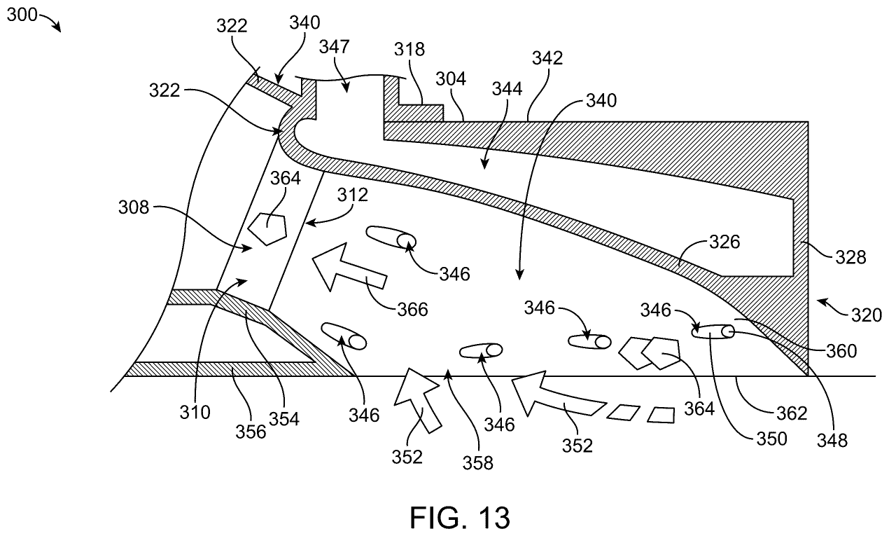

The inlet flow director 300 may include a collector 302 and a scourer 304. Within some examples, the scourer 304 and the collector 302 may be attached via one or more outer flanges 303 and fasteners 305 (see, e.g., FIG. 11). In some examples, the collector 302 may be provided in the form of a debris collection bag. As best shown in FIGS. 12 and 13, the collector 302 may include a trap 306 and a connector 308. The connector 308 may removably engage and thus connect or link the scourer 304 to the trap 306 of the collector 302. In some aspects, the trap 306 may be formed of textile netting to catch debris while allowing water to pass through the trap 306. The connector 308 may define an intake passage 310, an upstream opening 312, and a downstream opening 314. The upstream opening 312 may be in fluid communication with the downstream opening 314 via the intake passage 310, and the downstream opening 314 may be provided between the trap 306 and the upstream opening 312. The connector 308 may include a first tubular wall 316 engaged with the trap 306.

As best shown in FIG. 12, the scourer 304 may include a coupling 318 and a sprayer portion 320. The coupling 318 may include a second tubular wall 322 and a flange 324, whereby the second tubular wall 322 may removably receive the first tubular wall 316 of the collector 302. In some instances, the trap 306 may abut the flange 324. The sprayer portion 320 may be defined by an upper inner wall 326 and a front wall 328. The upper inner wall 326 may be curvilinear and may include a top region 330 transitionally connected to a first side region 332 and a second side region 334. The upper inner wall 326 may be defined by an upstream edge 336 and a downstream end 338, whereby the upper inner wall 326 connects to the second tubular wall 322 at the downstream end 338. The upper inner wall 326 may partially define a flow channel 340. The first side region 332 may be nearer to the second side region 334 at the downstream end 338 than at the upstream edge 336. Thus, the flow channel 340 may narrow transversely from the upstream edge 336 to the downstream end 338. In other words, the flow channel 340 may be transversely trapezoidal.

The sprayer portion 320 may further include an upper outer wall 342 (see FIG. 13). The upper outer wall 342, the second tubular wall 322, the flange 324, the upper inner wall 326, and the front wall 328 may define a supply chamber 344. Additionally, the upper inner wall 326 (e.g., the top region 330, the first side region 332, and the second side region 334), may include one or more jets 346. The one or more jets 346 may extend through the upper inner wall 326. Thus, the supply chamber 344 may be in fluid communication with the flow channel 340 via the one or more jets 346. More specifically, each of the one or more jets 346 may include an opening 348 and a slot 350 provided in the upper inner wall 326. The slots 350 may be arranged to be downstream of the openings 348 and directed toward the upstream opening 312. For example, in operation, when the supply chamber 344 is filled with pressurized water, the pressurized water may spray downstream out of the jets 346 toward the upstream opening 312, as indicated by the jet arrows 352.

In some examples, the inlet flow director 300 may include an inlet 347 as shown in FIGS. 11 and 13. In some instances, the inlet 347 may be designed to serve as a mounting boss for a hose (not shown). For example, the hose may be mounted to the inlet 347 via a fastener such as a mender nut or hose clamp. The inlet 347 may be in fluid communication with and provide a supply of pressurized water to a manifold or the supply chamber 344. In other instances, more than one inlet 347 may be provided.

Additionally, in some instances, the sprayer portion 320 may include a lower inner wall 354 and a lower outer wall 356. The lower inner wall 354 may further define the flow channel 340 and the lower inner wall 354 and the upper inner wall 326 may define a lower opening 358 that is in fluid communication with the flow channel 340. Additionally, the upper inner wall 326 may include a leading corner 360 that, in some examples, is rounded. In some instances, the lower inner wall 354 may support the collector 302. For example, in operation, the one or more jets 346 may be oriented to spray a pool surface 362 obliquely and/or to spray toward the upstream opening 312, as indicated by the jet arrows 352. Thus, as a pool cleaner having the inlet flow director 300 moves along the pool surface 362, the jets 346 may work to spray, stir up, dislodge, and/or direct debris 364 from the pool surface 362 toward the upstream opening 312 and into the intake passage 310. Further in operation, once the debris 364 enters the intake passage 310, the debris 364 may be moved via venturi effect through the intake passage 310 toward the collector 302, as indicated by the flow arrow 366.

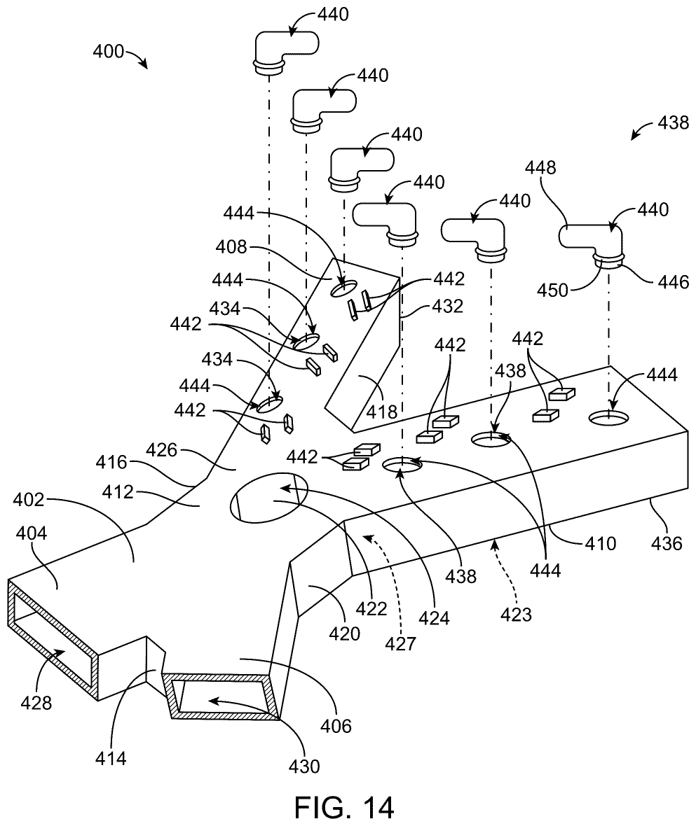

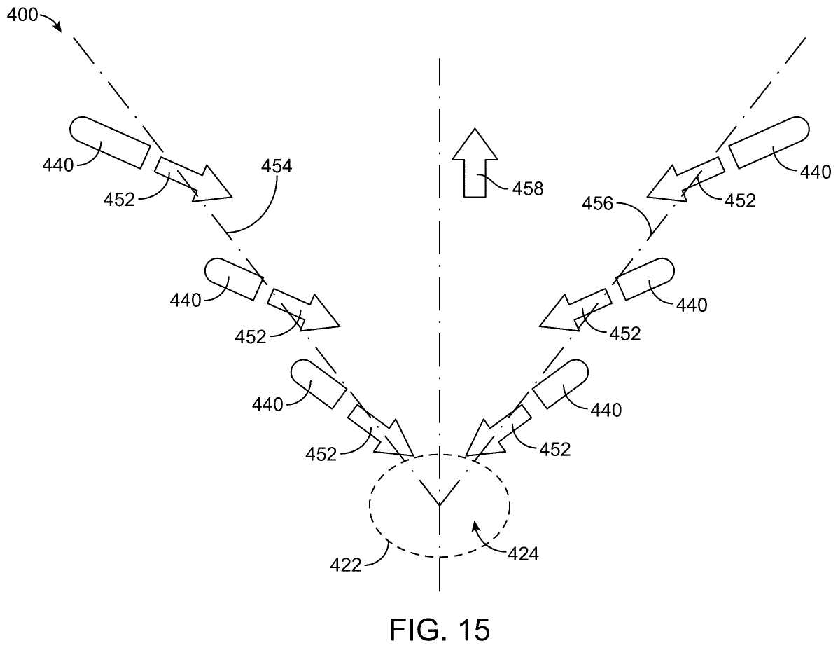

FIGS. 14 and 15 illustrate a fifth example inlet flow director 400 in accordance with the teachings of this disclosure. In some instances, the inlet flow director 400 may be included in the pool cleaner 10 of FIGS. 1 and 2. In other instances, the inlet flow director 400 may be added onto and thus used in conjunction with the pool cleaner 10. For example, in some instances the inlet flow director 400 may be coupled to the body 11 of pool cleaner 10. The inlet flow director 400 may be designed to direct debris toward an intake or suction passage, such as suction passage 38 of pool cleaner 10 (shown in FIG. 1), through which the debris is carried via venturi effect suction toward the debris collection system (not shown). In other examples, the inlet flow director 400 may be adapted for compatibility with a range of pool cleaning devices to accommodate various pool surfaces and user preferences. The design of the inlet flow director 400 may incorporate modular features to facilitate retrofitting onto existing pool cleaner models, enhancing versatility and ease of installation.

The inlet flow director 400 may be provided in the form of a central section 402, a first supply arm 404, a second supply arm 406, a first jet arm 408, and a second jet arm 410. The central section 402 may be defined by a bottom plate 412 connected to a first side 414, a second side 416, a third side 418, a fourth side 420, and a tubular wall 422. The central section 402 may also include a top plate 423 connected to the first side 414, the second side 416, the third side 418, the fourth side 420, and the tubular wall 422. Thus, the top plate may be positioned opposite the bottom plate 412. Additionally, the tubular wall 422 may be disposed between the first side 414 and the third side 418, and the tubular wall 422 may be disposed between the second side 416 and the fourth side 420. The tubular wall 422 may define an inlet passage 424 within the central section 402 that places a bottom outer surface 426 of the bottom plate 412 in fluid communication with a top outer surface (not shown) of the top plate. Further, the bottom plate 412, the first side 414, the second side 416, the third side 418, the fourth side 420, the tubular wall 422, and the top plate may define an interior flow chamber 427.

The first supply arm 404 and the second supply arm 406 may be connected to the central section 402. The first supply arm 404 and the second supply arm 406 may be generally tubular, and in some instances, the first supply arm 404 and the second supply arm 406 may be rectangularly tubular. The first supply arm 404 may define a first supply branch 428, and the second supply arm 406 may define a second supply branch 430. The first supply branch 428 and the second supply branch 430 may be in fluid communication with the flow channel 427. More specifically, the first supply arm 404 may be connected to the bottom plate 412, the top plate, the first side 414, and the second side 416. Further, the second supply arm 406 may be connected to the bottom plate 412, the top plate, the first side 414, and the fourth side 420. In operation, the first supply arm 404 and the second supply arm 406 may provide pressurized water into the flow chamber of the central section 402 via the first supply branch 428 and the second supply branch 430.

The first jet arm 408 and the second jet arm 410 may be connected to the central section 402 and extend outwardly therefrom. In some instances, the first jet arm 408 and the second jet arm 410 may extend outwardly from the central section 402 in a direction opposite of the first and second supply arms 404, 406. The first jet arm 408 and the second jet arm 410 may be generally tubular, and in some instances, may be rectangularly tubular. In some examples, the first jet arm 408 may include a first jet conduit 432 that defines a first jet branch 434, and the second jet arm 410 may include a second jet conduit 436 that defines a second jet branch 438. The first jet branch 434 and the second jet branch 438 may be in fluid communication with the flow channel 427. More specifically, the first jet arm 408 may be connected to the bottom plate 412, the top plate, the first side 414, and the third side 418. Further, the second jet arm 410 may be connected to the bottom plate 412, the top plate, the third side 418, and the fourth side 420. In operation, the first jet arm 408 and the second jet arm 410 may receive pressurized water from the flow chamber of the central section 402.

The first jet arm 408 and the second jet arm 410 may include one or more directional jets 440 and one or more orienting ribs 442. The one or more directional jets 440 may respectively insert into one or more jet openings 444 of the first and second jet arms 408, 410 defined in the first jet conduit 432 and the second jet conduit 436. In some instances, the one or more jet openings 444 may be in fluid communication with the flow channel 427 directly. In other instances, the one or more jet openings 444 may be in fluid communication with the flow channel 427 via the first and second jet branches 434, 438. The one or more orienting ribs 442 may extend outwardly from the first jet conduit 432 and the second jet conduit 436. In some instances, the one or more orienting ribs 442 may be arranged in pairs proximate to each of the one or more jet openings 444.

Referring still to FIGS. 14 and 15, each of the one or more directional jets 440 include an inlet 446 connected to an outlet 448. Additionally, each of the one or more directional jets 440 may include a connection member 450. that circumscribes the inlet 446. In some examples, the connection member 450 may be provided in the form of an O-ring. The inlets 446 may extend through the first jet conduit 432 and the second jet conduit 436 via the one or more jet openings 444. The outlets 448 and the connection member 450 may seat against the first jet conduit 432 and the second jet conduit 436. Further, in some instances, each outlet 448 may mount between and engage a pair of the orienting ribs 442. Thus, the one or more of directional jets 440 may sealingly engage the first jet conduit 432 and the second jet conduit 436. Moreover, the one or more directional jets 440 may be rotationally attached relative to the first jet conduit 432 and the second jet conduit 436. Thus, the one or more direction jets 440 may be movable relative to the first and second jet arms 408, 410.

As best shown in FIG. 15, the one or more jets 440 may be oriented toward the inlet passage 424. Within some examples, the orientation of the one or more jets 440 may be determined through fluid dynamic modeling to ensure optimal convergence of flow lines toward the inlet passage 424, thereby maximizing debris conveyance efficiency. In some aspects, the one or more jets 440 may be oriented to spray a pool surface (not shown) obliquely. For example, in operation, pressurized water may be supplied to the one or more jets 440. In some instances, the pressurized water may be delivered via a dedicated pump or diverted from the main pool circulation system, with the supply pressure regulated by adjustable valves or electronic controllers to accommodate varying cleaning requirements. The pressurized water may be sprayed via the one or more jets 440 toward the inlet passage 424. Each of the one or more jets 440 may incorporate a replaceable nozzle tip (not shown), allowing for customization of spray angle, flow rate, and droplet size, which can be selected based on the type of debris or the characteristics of the pool surface. As the pressurized water is sprayed, streams of water 452 produced by the one or more jets 440 may overlap to form a first virtual fence 454 and a second virtual fence 456. In some aspects, the first virtual fence 454 and the second virtual fence 456 may intersect proximate the inlet passage 424. Thus, as a pool cleaner having the inlet flow director 400 moves along a pool surface, as indicated by a direction arrow 458, the one or more jets 440 may work to spray, stir up, dislodge, collect, and/or direct debris from the pool surface toward and into the inlet passage 424. Further in operation, once the debris enters the inlet passage 424, the debris may be moved via venturi effect through the inlet passage 424 toward the debris collection system (not shown).

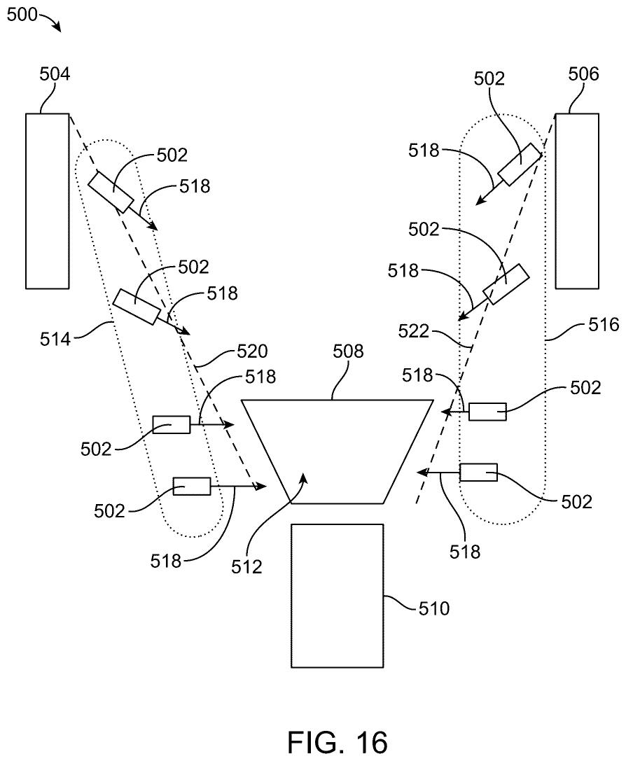

Turning to FIG. 16, a schematic of a sixth example inlet flow director 500 is illustrated in accordance with the teachings of this disclosure. In some instances, the inlet flow director 500 may be included in the pool cleaner 10 of FIGS. 1 and 2. In other instances, the inlet flow director 500 may be added onto and thus used in conjunction with the pool cleaner 10. For example, in some instances the inlet flow director 500 may be coupled to the body 11 of pool cleaner 10. The inlet flow director 500 may work to direct debris toward an intake or suction passage, such as the suction passage 38 of pool cleaner 10 (shown in FIG. 1), through which the debris is carried via venturi effect suction toward the debris collection system (not shown). The inlet flow director 500 may include one or more jets 502, a first front wheel 504, a second front wheel 506, and an inlet 508. In some aspects, the inlet flow director 500 may also include a rear wheel 510. In some aspects, the rear wheel 510 may be steerable. In some aspects, the pool cleaner 10 may be modified to replace the plurality of wheels 28 of FIGS. 1 and 2 with the first front wheel 504, the second front wheel 506, and/or the rear wheel 510. In other examples, the inlet flow director 500 may be adapted for compatibility with a range of pool cleaning devices having a variety of drive mechanisms, such as tracks or rollers, to accommodate various pool surfaces and user preferences. The design of the inlet flow director 500 may incorporate modular features to facilitate retrofitting onto existing pool cleaner models, enhancing versatility and ease of installation.

The inlet 508 may be generally tubular and may define an inlet passage 512. In some aspects, the inlet 508 may be imparted with a trapezoidally tubular shape. The one or more jets 502 may be provided between the first front wheel 504 and the second front wheel 506. Additionally, the one or more jets 502 may be arranged into a first row 514 and a second row 516, and the inlet 508 may be disposed between the first row 514 and the second row 516. The first front wheel 504 and the second front wheel 506 may be forward of the inlet 508, and the inlet 508 may be forward of the rear wheel 510.

Still referring to FIG. 16, the one or more jets 502 may be oriented toward the inlet passage 512. In some aspects, the one or more jets 502 may be oriented to spray a pool surface (not shown) obliquely. For example, in operation, pressurized water may be supplied to the one or more jets 502, which is sprayed via the one or more jets 502 toward the inlet passage 512. As the pressurized water is sprayed, overlapping streams 518 form a first virtual skirt 520 and a second virtual skirt 522. The inlet 508 may be between the first virtual skirt 520 and the second virtual skirt 522. Thus, as a pool cleaner having the inlet flow director 500 moves along the pool surface, the one or more jets 502 may work to spray, stir up, dislodge, collect, and/or direct debris from the pool surface toward and into the inlet passage 512. Further in operation, once the debris enters the inlet passage 512, the debris is moved via venturi effect through the inlet passage 512 toward the debris collection system (not shown).

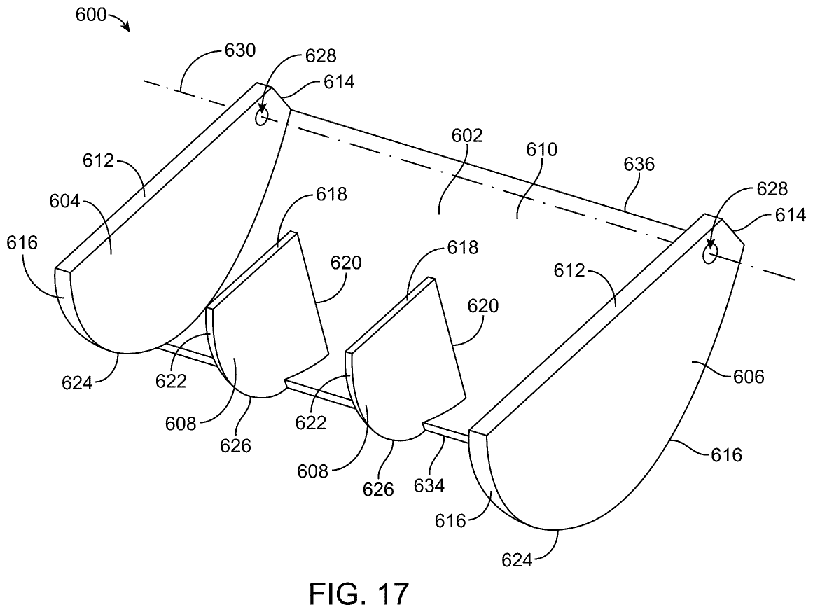

FIG. 17 illustrates a retractable skirt 600 in accordance with the teachings of this disclosure. In some instances, the retractable skirt 600 may be included in the pool cleaner 10 of FIGS. 1 and 2. In other instances, the retractable skirt 600 may be added onto and thus used in conjunction with the pool cleaner 10. In some examples, the retractable skirt 600 may be coupled to the body 11 of the pool cleaner 10. The retractable skirt 600 may work to direct debris toward an intake or suction passage, through which the debris is carried via venturi effect suction toward the debris collection system (not shown). Within some examples, the retractable skirt 600 may be attached to the pool cleaner 10 in one or more orientations to direct debris to the suction passage 38. In some examples, the retractable skirt 600 may include a separate suction passage.

The retractable skirt 600 may include a scoop plate 602, having a first end plate 604 and a second end plate 606, and one or more ribs 608 positioned between and parallel to the first end plate 604 and the second end plate 606. The scoop plate 602 may be connected to the first end plate 604 and the second end plate 606. In some instances, the scoop plate 602 may be positioned between the first end plate 604 and the second end plate 606. The first end plate 604 and the second end plate 606 may each be defined by a first upper edge 612, a second upper edge 614, and a first lower edge 616. The one or more ribs 608 may extend outwardly from a front surface 610 of the scoop plate 602.

The one or more ribs 608 may each have a third upper edge 618, a fourth upper edge 620, and a second lower edge 622. In some aspects, the first upper edges 612, the second upper edges 614, the third upper edges 618, and the fourth upper edges 620 may be substantially straight or linear. Additionally, in other instances, the first lower edges 616 and the second lower edges 622 may be curved. The curvature of the first end plate 604 and the second end plate 606 may be defined by the first lower edges 616 and the curvature of the one or more ribs 608 may be defined by the second lower edge 622. Thus, the first end plate 604 and the second end plate 606 may each have a first apex 624. Further, the one or more ribs 608 may each have a second apex 626. In some examples, the first apexes 624 and the second apexes 626 may be rounded. In other examples, the first apexes 624 and the second apexes 626 may have another suitable shape. The first end plate 604 and the second end plate 606 may each have a pivot opening 628. The pivot openings 628 may be aligned with one another along a pivot axis 630.

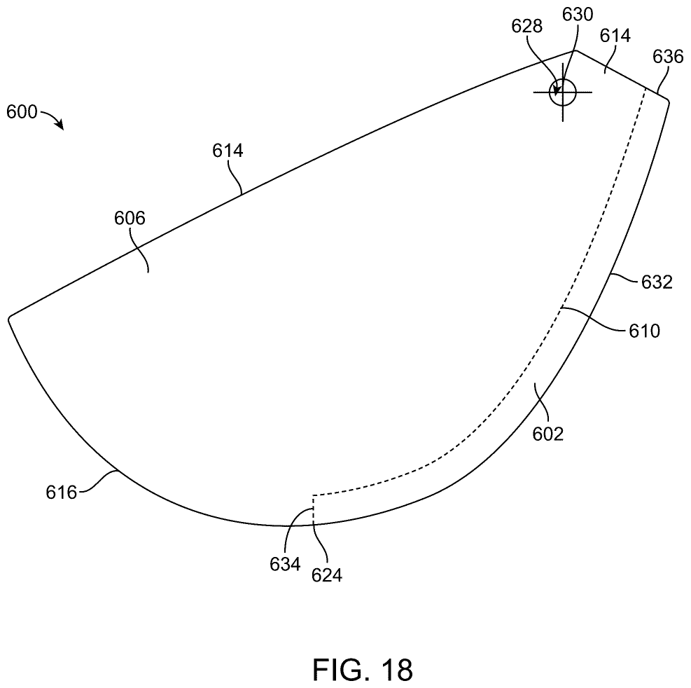

Referring to FIG. 18, the first lower edges 616 of the retractable skirt 600 may be curved similarly to and flush with a rear surface 632 of the scoop plate 602. Further, the scoop plate 602 may extend partially along the first lower edges 616 from the second upper edges 614 toward the first apexes 624. Thus, a horizontal leading edge 634 of the scoop plate 602 may be aligned with the first apexes 624. Additionally, a horizontal trailing edge 636 of the scoop plate 602 may be flush with the second upper edges 614. The retractable skirt 600 shown within FIG. 18 may be used in combination of the other aspects of the present disclosure. It should be known that the profile of the retractable skirt 600 may be various sizes and shapes to accommodate the pool cleaner 10. It should be known that the retractable skirt 600 may be used in other pool cleaners or with other debris collections systems.

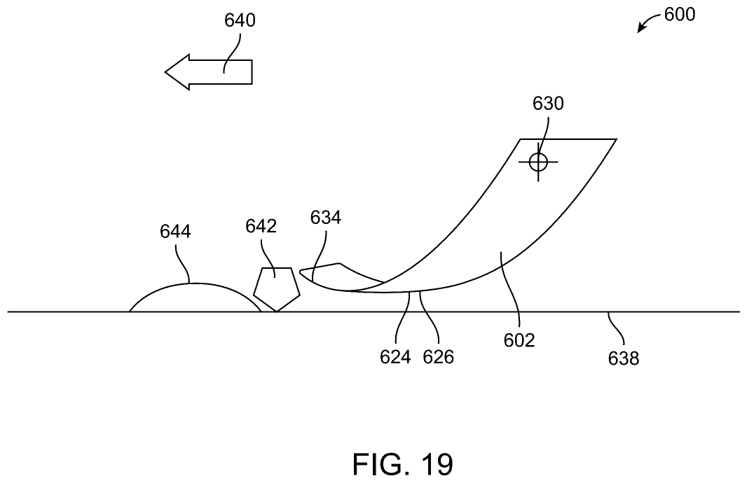

Turning to FIG. 19, in operation, as a pool cleaner (e.g., pool cleaner 10) having the retractable skirt 600 moves along a pool surface 638, as indicated by a direction arrow 640, the retractable skirt 600 may work to scrape, stir up, dislodge, and/or direct loose debris 642 from the pool surface 638 toward a debris collection system (not shown). It should be known that the retractable skirt 600 may be used in or in conjunction with other pool cleaners or with other debris collections systems as described by the present disclosure. In addition, as the retractable skirt 600 moves along the pool surface 638, the horizontal leading edge 634 may contact the debris 642, and the scoop plate 602 may lift the debris 642 off the pool surface 638. In some aspects, where the pool surface 638 is relatively smooth, the first apexes 624 and the second apexes 626 may contact and substantially slide along the pool surface 638. When the retractable skirt 600 encounters a fixed obstacle 644 along the pool surface 638, one or more of the first apexes 624 and the second apexes 626 may contact and slide over the fixed obstacle 644, causing the retractable skirt 600 to pivot about the pivot axis 630.

Specific aspects of improved pool cleaners according to the present disclosure have been described for the purpose of illustrating the manner in which the disclosure can be made and used. It should be understood that the implementation of other variations and modifications of this disclosure and its different aspects will be apparent to one skilled in the art, and that this disclosure is not limited by the specific aspects described. Features described in one aspect can be implemented in other aspects. The subject disclosure is understood to encompass the present disclosure and any and all modifications, variations, or equivalents that fall within the spirit and scope of the basic underlying principles disclosed and claimed herein.

What is claimed is:

1. An inlet flow director for a pool cleaner, comprising:
a collector having an intake portion;
a scourer connected to the collector, the scourer having one or more side walls; and
one or more jets positioned in and extending through the one or more side walls, wherein the one or more jets direct debris toward the intake portion.

2. The inlet flow director of claim 1, wherein the scourer is coupled to the collector via a connector.

3. The inlet flow director of claim 1, wherein the one or more jets are oriented to spray fluid streams to dislodge the debris from a pool surface to direct the debris toward the intake portion.

4. The inlet flow director of claim 1, wherein the one or more jets are moveable relative to the one or more side walls.

5. The inlet flow director of claim 1, further comprising one or more mounting assemblies each of the one or more mounting assemblies having a receiver, a mounting opening, and a retaining collar.

6. The inlet flow director of claim 5, wherein the one or more mounting assemblies are positioned in the one or more side walls of the scourer.

7. The inlet flow director of claim 5, wherein a coupler of each jet is positioned about the one or more mounting assemblies and is retained by the retaining collar.

8. The inlet flow director of claim 5, wherein a sprayer of each jet is positioned about the one or more mounting assemblies and protrudes through the receiver.

9. The inlet flow director of claim 1, wherein the scourer is imparted with a substantially trapezoidal shape.

10. The inlet flow director of claim 1, wherein each of the one or more jets include a mounting ball, a coupler, and a sprayer extending from the mounting ball.

11. The inlet flow director of claim 10, wherein the mounting ball, the coupler, and the sprayer define a partially conical jet channel.

12. The inlet flow director of claim 1, further comprising a supply chamber, wherein the supply chamber provides pressurized water to the one or more jets.

13. An inlet flow director for a pool cleaner, comprising:
a central section with an inlet passage positioned therein;
one or more supply arms extending from the central section, wherein the one or more supply arms are designed to provide a supply of pressurized water; and
one or more jet arms extending from the central section in a direction that is opposite the one or more supply arms, the one or more jet arms including one or more jets,
wherein the one or more jets are oriented to spray fluid streams to dislodge debris from a pool surface and direct the debris toward the inlet passage.

14. The inlet flow director of claim 13, wherein each of the one or more jets includes an inlet and an outlet.

15. The inlet flow director of claim 14, wherein the one or more jet arms include one or more jet openings, and wherein the inlet of each of the one or more jets is connected to the one or more jet arms via the one or more jet openings.

16. The inlet flow director of claim 13, wherein the one or more jets are movable relative to the one or more jet arms.

17. The inlet flow director of claim 13, wherein the fluid streams of water produced by the one or more jets overlap to form a first virtual fence and a second virtual fence to direct the debris toward the inlet passage.

18. The inlet flow director of claim 13, further comprising a flow chamber, wherein the one or more supply arms provide pressurized water to the one or more jets via the flow chamber.

19. A pool cleaner, comprising:
a body having a suction passage;
a retractable skirt coupled to the body of the pool cleaner, the retractable skirt having a scoop plate with a front surface extending between a first end plate and a second end plate; and
one or more ribs positioned between the first end plate and the second end plate, the one or more ribs extending outwardly from the front surface of the scoop plate and positioned parallel to the first end plate and the second end plate,
wherein the retractable skirt dislodges debris from a pool surface and directs the debris toward the suction passage.

20. The pool cleaner of claim 19, wherein the retractable skirt includes a pivot opening on the scoop plate designed to pivot about a pivot axis to slide over one or more fixed obstacles on the pool surface.
